(19) United States
(12) Patent Application Publication
(10) Pub. No.: US 2012/0162890 A1
(43) Pub. Date: Jun. 28, 2012

(54) ELECTRONIC DEVICE

(75) Inventors: Wei-Pin Chuang, Taipei City (TW); Jih-Houng Lee, Taipei City (TW); Yun-Lung Ke, Taipei City (TW)

(73) Assignee: COMPAL ELECTRONICS, INC., Taipei City (TW)

(21) Appl. No.: 13/337,167

(22) Filed: Dec. 26, 2011

Related U.S. Application Data
(60) Provisional application No. 61/427,463, filed on Dec. 27, 2010.

(51) Int. Cl. G06F 1/16

(52) U.S. Cl. 361/679.09

(57) ABSTRACT

An electronic device includes a first casing, a second casing, a keyboard module and a radiation unit. The first casing has a display module. The second casing is pivoted to the first casing. The keyboard module is disposed on the second casing, where the keyboard module has an accommodation portion therein. The radiation unit is disposed in the accommodation portion.

### CROSS-REFERENCE TO RELATED APPLICATION

This application claims the priority benefit of U.S. provisional application serial No. 61/427,463, filed on Dec. 27, 2010. The entirety of the above-mentioned patent application is hereby incorporated by reference herein and made a part of this specification.

### BACKGROUND OF THE INVENTION

1. Field of the Invention

The present invention generally relates to an electronic device, in particular, to an electronic device having a radiation unit.

2. Description of Related Art

As notebook computers have the same functions as common desktop computers and are portable due to the light and thin design, the notebook computers have become a portable tool indispensable for some users. With the price falling of the notebook computer, some users even directly replace the desktop computer with a notebook computer. Additionally, with the rise of wireless networks, notebook computers are not restricted by network cables, so that the notebook computers can access the Internet everywhere in coverage areas of the wireless networks.

Generally, a notebook computer includes a base, a keyboard module disposed on the base, an upper cover pivoted to the base, and a display module disposed on the upper cover. The notebook computer needs to have an antenna disposed thereon for receiving and sending wireless network signals, and the antenna is always disposed in the upper cover of the notebook computer. As for the current casing design, it is usually desired to use a metal material to improve the overall sense of quality of electronic products. In order to avoid the shielding effect of metal, a plastic material antenna cover is disposed at a position on the upper cover corresponding to the antenna, so as to avoid the influence of the metal on the signal receiving function of the antenna. Based on the current technologies, the upper cover must be divided into two parts, that is, a metal material main body and a plastic material antenna cover, resulting in lack of the aesthetic experiment of integral forming.

### SUMMARY OF THE INVENTION

Accordingly, the present invention is directed to an electronic device, and more particularly to an electronic device with a radiation unit disposed in a keyboard module.

The present invention provides an electronic device, which includes a first casing, a second casing, a keyboard module, and a radiation unit. The first casing has a display module. The second casing is pivoted to the first casing. The keyboard module is disposed on the second casing, where the keyboard module has an accommodation portion. The radiation unit is disposed in the accommodation portion.

In an embodiment of the present invention, the first casing has an upper cover, and the upper cover is integrally formed.

In an embodiment of the present invention, the first casing has an upper cover, and the upper cover has an electromagnetic wave shielding outer surface.

In an embodiment of the present invention, the first casing has an upper cover, and the upper cover has an evenly distributed electromagnetic wave shielding material.

In an embodiment of the present invention, the keyboard module has two long edges opposite to each other and two short edges opposite to each other, and the accommodation portion is located at one of the two long edges.

In an embodiment of the present invention, the keyboard module includes a base plate, key units, and a frame. The key units are disposed on the base plate. The frame is disposed on the base plate and covers a part of the key units, where the accommodation portion is located between the key units and the frame.

In an embodiment of the present invention, the material of the frame is plastics.

In an embodiment of the present invention, the electronic device further includes a signal processing module and a connecting cable. The signal processing module is disposed in the second casing. The base plate has an opening, and the connecting cable pass through the opening and is connected between the radiation unit and the signal processing module.

In an embodiment of the present invention, the radiation unit is an antenna unit.

Based on the above, the radiation unit is disposed in the keyboard module, but not disposed on the first casing. As compared with the prior art, the first casing does not need to have an antenna cover additionally disposed thereon, but can have an integrally formed outer surface, thus bringing aesthetic effects to a user. Additionally, the radiation unit is disposed at the keyboard module, and is not influenced by the shielding effect of the first casing, and can maintain good signal receiving quality.

In order to make the aforementioned features and advantages of the present invention more comprehensible, embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a three-dimensional view of an electronic device according to an embodiment of the present invention.

FIG. 2 is a partial top view of the electronic device in FIG. 1 after being expanded.

FIG. 3 is an exploded view of a keyboard module in FIG. 2.

FIG. 4 is a partial side view of the keyboard module in FIG. 2.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

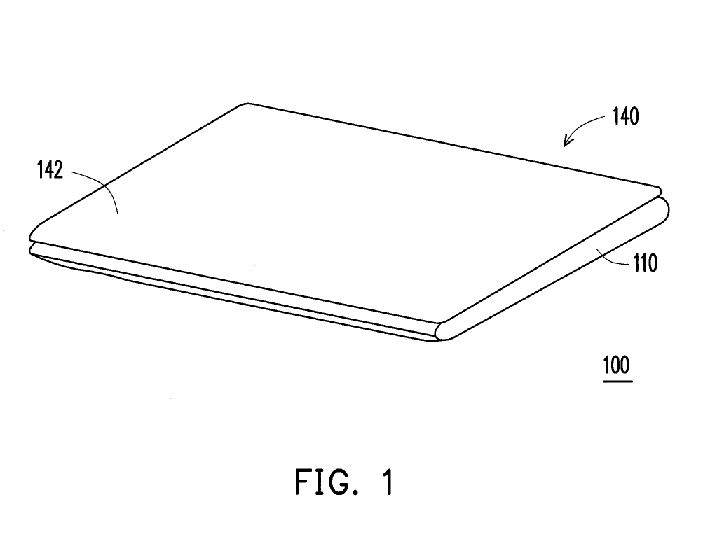

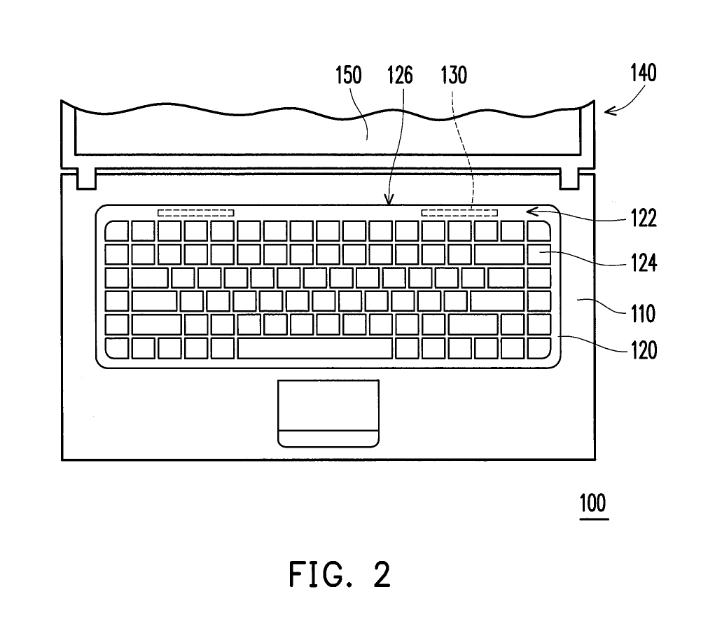

FIG. 1 and FIG. 2 are schematic views of an electronic device according to an embodiment of the present invention. The electronic device 100 of this embodiment is, for example, a notebook computer, and includes a first casing 140, a second casing 110, a keyboard module 120, and a radiation unit 130 (two radiation units are shown). The second casing 110 is pivoted to the first casing 140, so that the first casing 140 is suitable for being expanded or closed on the second casing 110 (an expanded state is shown). The first casing 140 has a display module 150. The keyboard module 120 is disposed on the second casing 110, where the keyboard module 120 has an accommodation portion 122 therein. The radiation unit 130 is, for example, an antenna unit, and is disposed in the accommodation portion 122.

In this embodiment, the first casing 140 has an upper cover 142, and has the electromagnetic shielding properties. Based on the current technologies, the upper cover 142 may be integrally formed, for example, through metal pressing, and the material of the upper cover 142 may be aluminium, magnesium, or other metals, alloys, or non-metal conductive materials that can shield electromagnetic waves. Additionally, the upper cover 142 may also have an electromagnetic wave shielding outer surface, for example, the outer surface of the upper cover is covered with a metal material layer, and the metal material layer may be made of aluminium, magnesium, or other metals, alloys, or non-metal conductive materials that can shield electromagnetic waves. In addition, the material of the upper cover 142 may also include an evenly distributed electromagnetic wave shielding material, for example, the upper cover may be a composite material casing, for example, a carbon fiber casing, and the upper cover has an evenly distributed structure reinforced layer, for example, a metal network structure layer or a non-metal conductive material layer. Definitely, the upper cover 142 may also be integrally formed through plastics injection molding, and has particles having a reinforced structure and conductive properties, such as metal particles, evenly distributed therein.

In this embodiment, the keyboard module 120 has a plurality of key units 120b, and the accommodation portion 122 for accommodating the radiation unit 130 is located between the key units 120b and a side edge 126 of the keyboard module 120. As shown in FIG. 1, the keyboard module 120 has two long edges opposite to each other and two short edges opposite to each other, and the side edge 126 is one of the two long edges. In other words, the accommodation portion 122 is located at one of the two long edges of the keyboard module 120. In other embodiments, the accommodation portion 122 may also be located at other appropriate positions of the keyboard module 120, which is not limited in the present invention.

The radiation unit 130 of this embodiment is, for example, used for receiving a wireless local area network (WLAN) signal or a wireless wide area network (WWAN) signal, but the present invention is not limited thereto, and in other embodiments, the radiation unit 130 may also be used for receiving other types of signals.

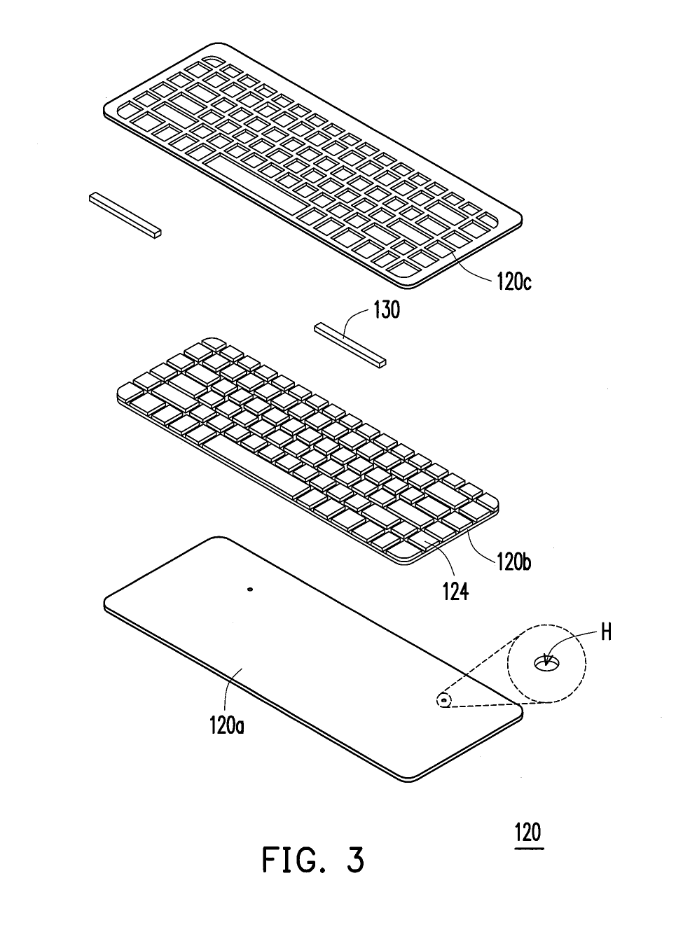

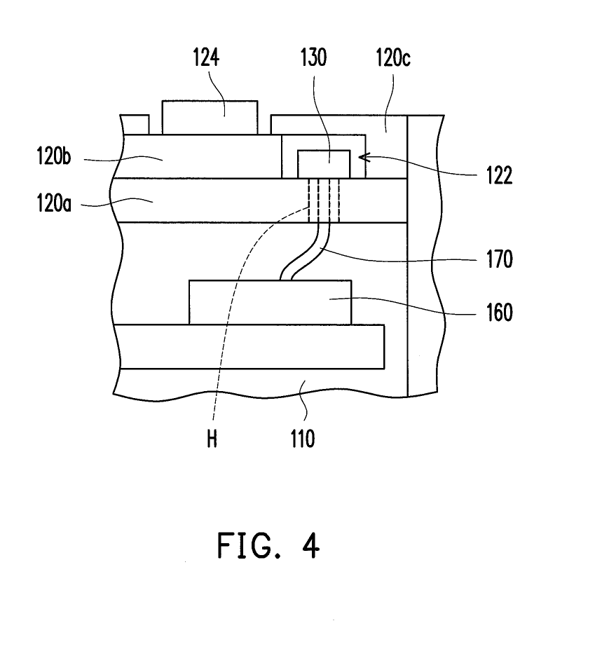

FIG. 3 and FIG. 4 are schematic views of a keyboard module of an electronic device of the present invention. Referring to FIG. 3 and FIG. 4, in detail, the keyboard module 120 of this embodiment includes a base plate 120a, key units 120b, and a frame 120c. The key units 120b are disposed on the base plate 120a and has the key body 124, and the material of the frame 120c is, for example, plastics, and the frame 120c is disposed on the base plate 120a and covers a part of the key units 120b. The accommodation portion 122 for disposing the radiation unit 130 is formed in a gap between the key units 120b and the frame 120c, so the electronic device 100 does not need to provide additional space for disposing the radiation unit 130.

The electronic device 100 of this embodiment further includes a signal processing module 160 and a connecting cable 170. The signal processing module 160 is disposed in the second casing 110, the base plate 120a has an opening H, and the connecting cable 170 passes through the opening H and is connected between the radiation unit 130 and the signal processing module 160, so that the signal processing module 160 can receive a signal from the radiation unit 130 or send a signal through the radiation unit 130.

In view of the above, the radiation unit of the present invention is disposed in the keyboard module, but not disposed in the first casing. As compared with the prior art, the first casing does not need to have an antenna cover additionally disposed thereon, but can have an integrally formed outer surface, thus bringing aesthetic effects to a user. Additionally, the radiation unit is disposed at the keyboard module, and is not influenced by the shielding effect of the first casing, and can maintain good signal receiving quality.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An electronic device, comprising:
a first casing, having a display module;
a second casing, pivoted to the first casing;
a keyboard module, disposed on the second casing, wherein the keyboard module has an accommodation portion therein; and
a radiation unit, disposed in the accommodation portion.

2. The electronic device according to claim 1, wherein the first casing has an upper cover, and the upper cover is integrally formed.

3. The electronic device according to claim 1, wherein the first casing has an upper cover, and the upper cover has an electromagnetic wave shielding outer surface.

4. The electronic device according to claim 1, wherein the first casing has an upper cover, and the upper cover has an evenly distributed electromagnetic wave shielding material.

5. The electronic device according to claim 1, wherein the keyboard module has two long edges opposite to each other and two short edges opposite to each other, and the accommodation portion is located at one of the two long edges.

6. The electronic device according to claim 1, wherein the keyboard module comprises:
a base plate;
key units, disposed on the base plate; and
a frame, disposed on the base plate and covering a part of the key units, wherein the accommodation portion is located between the key units and the frame.

7. The electronic device according to claim 6, wherein the material of the frame is plastics.

8. The electronic device according to claim 6, further comprising:
a signal processing module, disposed inside the second casing; and
a connecting cable, wherein the base plate has an opening, and the connecting cable passes through the opening and is connected between the radiation unit and the signal processing module.

9. The electronic device according to claim 1, wherein the radiation unit is an antenna unit.
